(19) United States
(12) Patent Application Publication
(10) Pub. No.: US 2006/0141346 A1
(43) Pub. Date: Jun. 29, 2006

(54) Solid electrolyte thermoelectrochemical system

(76) Inventors: John Howard Gordon, Salt Lake City, UT (US); Ashok V. Joshi, Salt Lake City, UT (US); Shekar H. Balagopal, Sandy, UT (US)

Correspondence Address: CERAMATEC, INC., 2425 SOUTH 900 WEST, SALT LAKE CITY, UT, 84119, US

(21) Appl. No.: 11/286,637

(22) Filed: Nov. 23, 2005

Related U.S. Application Data
(60) Provisional application No. 60/522,945, filed on Nov. 23, 2004.

(51) Int. Cl. H01M 6/36

(52) U.S. Cl. 429/112; 429/321; 429/322

(57) ABSTRACT

A solid electrolyte thermoelectrochemical system which employs a non-porous solid electrolyte as membrane between an anode compartment and a cathode compartment. The system utilizes the principles of a concentration cell using a non-porous inorganic solid electrolyte membrane and ionic solutions of differing concentration.

### RELATED APPLICATIONS

This application is related to and claims the benefit of U.S. Provisional Patent Application Ser. No.: 60/522,945, of Ashok V. Joshi and John H. Gordon filed on Nov. 23, 2004, and entitled “SOLID ELECTROLYTE THERMOELECTROCHEMICAL SYSTEM,” which is incorporated herein by this reference in its entirety.

### FIELD OF THE INVENTION

The present invention relates to thermally regenerative electrochemical systems for generating power or generating a fluid suitable for generating power such as hydrogen, employing non-porous solid electrolyte as a membrane between an anode compartment and a cathode compartment. More specifically, the present invention provides a thermally regenerative electrochemical system for power generation, or for generating a fluid suitable for generating power such as hydrogen, utilizing a concentration cell with a non-porous inorganic solid electrolyte membrane and ionic solutions of differing concentrations.

### BACKGROUND OF THE INVENTION

Thermally regenerative electrochemical systems have been produced and explored in the art to some degree. Concentration cells have been proposed that generate power upon immersion of a cathode and an anode in concentrated and dilute sulfuric acid,. respectively, for example. To date, however, no system has been proposed which utilizes non-porous, inorganic, ion-specific solid electrolyte to segregate the anode and the cathode and their solutions of differing concentrations. Systems described in the art generally utilize porous membranes or ion exchange polymers between two salt solutions. As a result, these systems transport solvent across the membrane in an uncontrolled manner, as well as the ions, thus resulting in a drop in efficiency and reduction of shelf life of the device.

In addition to the above, such regenerative systems must be regenerated often to maintain the concentration gradient across the membrane. This further decreases the life and usefulness of such cells and increases their costs of operation.

It would thus be an improvement in the art to provide a thermally regenerative electrochemical system for generating power, or for generating a fluid such as hydrogen suitable for generating power that has characteristics that may enable a lengthened shelf life, a longer useful operative life, and more efficient operation. Such a device and method are provided herein.

### BRIEF SUMMARY OF THE INVENTION

The present invention is directed to a method and design for a thermally regenerative electrochemical system utilizing a concentration cell with a non-porous, ion-specific solid electrolyte membrane, such as, but not limited to, a NASICON-type ceramic membrane. The systems of the present invention further incorporate a design that allows them to potentially enjoy higher efficiency, little or no transport of solvent across the membrane, substantially negligible effects of impurities on the membrane, substantially negligible parasitic losses due to the exchange of ions, a wide range of suitable operating temperatures (in some embodiments ranging from about −40 degrees C. to about 100° C., and in some instances up to about 500° C.), and a substantially negligible convection of solution under the thermal gradient between the anode and the cathode.

Other advantages and aspects of the present invention will become apparent upon reading the following description of the drawings and detailed description of the invention. These and other features and advantages of the present invention will become more fully apparent from the following figures, description, and appended claims, or may be learned by the practice of the invention as set forth hereinafter.

### BRIEF DESCRIPTION OF THE SEVERAL VIEWS OF THE DRAWINGS

In order that the manner in which the above-recited and other features and advantages of the invention are obtained will be readily understood, a more particular description of the invention briefly described above will be rendered by reference to specific embodiments thereof that are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a schematic view of a first embodiment of a thermoelectrochemical system of the present invention;

FIG. 2 is a schematic view of a second embodiment of a thermoelectrochemical system of the present invention having a regenerative heat source, heat sink, and fluid passages;

FIG. 3 is a schematic view of a third embodiment of a thermoelectrochemical system of the present invention having a regenerative heat source, a heat sink, and fluid passages;

FIG. 4 is a schematic view of a fourth embodiment of a thermoelectrochemical system of the present invention in which a bank of cells may be regenerated from a centralized heat source and a central heat sink; and

FIG. 5 is a schematic view of a fifth embodiment of a thermoelectrochemical system of the present invention in which the concentration cells are configured as bipolar cells in series to enable efficient means to achieve higher voltages than possible from single cells.

### DETAILED DESCRIPTION OF THE INVENTION

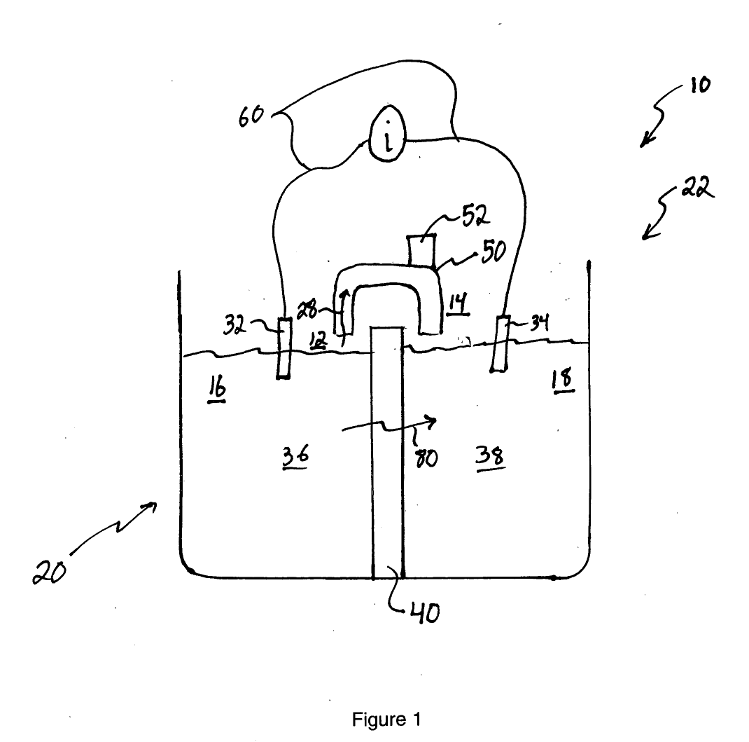

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the solid electrolyte thermoelectrochemical system and method of the present invention, as represented in FIGS. 1 through 5, is not intended to limit the scope of the invention, as claimed, but is merely representative of presently preferred embodiments of the invention.

The present invention thus provides thermoelectrochemical systems in which electrical energy may be generated or hydrogen produced using a non-porous ceramic solid electrolyte membrane. In one embodiment, the device includes a cell having an anode made up of a metal or conductive ceramic material in a concentrated ionic solution. The cell further includes a cathode of a metal or conductive ceramic in a dilute ionic solution. The cathode and anode are generally segregated from each other by a non-porous membrane comprising an ion-specific alkali ion solid electrolyte. A heat source is provided for heating the contents of the anode compartment to vaporize solvent vapor, in some instances in a controlled manner which may then be drawn from the anode into the cathode and made to condense, joining the catholyte. This serves to further concentrate the anode compartment and to dilute the cathode compartment. Thus, in some embodiments, it may be useful to provide systems to draw the vapor from the anode compartment into the cathode compartment to facilitate transport of the vapor from the anode chamber into the cathode.

In some embodiments, it may be possible to then place the cathode compartment in fluid communication with the anode compartment such that the liquid level in the cathode compartment is maintained as solvent condensate enters the cathode compartment and where any overflow may be transferred to the anode compartment. This may facilitate return of ions from the cathode compartment to the anode compartment as the fluid is transferred.

In still other embodiments, it may be useful to include means to provide electroactive gas such as oxygen to the cathode or hydrogen to the anode. In still others, it may be useful to provide means to vent generated electroactive gas such as oxygen from the anode or hydrogen from the cathode. It may further alternatively be useful to provide a means for recovering heat provided to anode compartment.

In many embodiments of the present invention, specific alkali ion solid electrolytes comprising NASICON ceramic materials may be used. The known advantage of these ionic conductors is their excellent ion conducting characteristics and selectivity for specific ions. NASICON materials with sodium ion conductivity have the general chemical formula of M₁₊ₓZrₓP₃₋ₓSiₓO₁₂, where M may be an alkali metal such as, without limitation, Na, Li, or K; and where 0≦x≦3. A second compositional family in which the Zr and P sites may be substituted by rare earth elements, including, but not limited to, Dy, Nd, Y, and mixtures thereof is represented by the general formula M₅RESi₄O₁₂ where M may be an alkali metal such as, without limitation, Na, Li, or K; and where RE is a rare earth element such as Dy (dysprosium) or Nd (Neodymium). Rare Earth-substituted NASICON materials have, in some instances, excellent sodium ion conductivity at ambient temperature as well as excellent selectivity in aqueous solutions. (See, e.g., U.S. Pat. No. 5,580,430) When sodium ions are substituted with other alkali ions (such as Li, K) then those materials have similar properties. These ceramic ion conductors are stable in various environments and have excellent selectivity to specific alkali ions, especially when their selectivity is compared to that of polymer electrolytes or membranes. These materials are also generally stable in organic as well as inorganic solvents and salts.

The use of NASICON-type materials in electrochemical concentration cells such as those taught herein may present an advantage in terms of efficiency because back diffusion of solvent through the membrane does not generally occur as it commonly does in the case of porous or polymer membranes.

In the systems of the present invention, when thermal energy is provided to the anode compartment solution, the solvent may become vaporized in a controlled manner and may travel via passage to the cathode compartment, where it may be condensed and added to the catholyte to dilute the cathode compartment solute. Heat must be removed either from the passage or from the cathode compartment to condense the solvent vapors transferred. The solvent condensation in the cathode compartment helps to keep the concentration of solvent low.

In some specific embodiments of the systems of the present invention, the cells may be configured such that as solvent is added to the compartment, the fluid level rises to result in overflow through a passage from the cathode chamber to the anode chamber such that catholyte is transported into the anode compartment. This overflow from the cathode compartment to the anode compartment may result in transport of ions to the anode compartment. When this occurs, cation loss from the anode compartment due to electrochemical transport through the membrane during operation of the cell may be at least partially offset. Thus, in some configurations, by providing heat to the anode compartment solution and subsequently cooling the vapor such that solvent liquid enters the cathode compartment, the ion concentration gradient can be maintained, even as cations transport across solid electrolyte ceramic membrane during the course of cell reactions.

Thus in some of the embodiments of the present invention, heat energy is converted into electrical energy. Such methods generally include the steps of providing heat to the anode compartment solution of an electrochemical cell utilizing a non-porous NASICON type alkali ion ceramic conductor as a membrane between the anode compartment and the cathode compartment where the anode compartment comprises a metal or conductive ceramic electrode and a high concentration of alkali ion-containing solution while the cathode compartment comprises a metal or conductive ceramic electrode and a low concentration of alkali ion-containing solution while the cathode compartment comprises metal or a conductive ceramic electrode and a low concentration of alkali ion-containing solution.

In embodiments of the invention, the electronically-conductive material selected for the anode and cathode may be chosen from silver, gold, platinum, rhodium, ruthenium, palladium, titanium, nickel, iron, copper, zinc and combinations thereof or may alternatively be made from electronically-conductive ceramic materials such as those comprising lanthanum or neodymium-based perovskite structured materials, ruthenium oxide composites, carbon and mixtures thereof. Other suitable electrode materials are known to one of ordinary skill in the art.

Heat recovered from condensing solvent vapor in the system may potentially be used to heat the anode compartment solution, thus increasing the conversion efficiency of thermal to electrical energy in the processes and devices of the present invention. The passage used to transfer solvent vapor from the anode compartment may also transport electroactive gas from the anode compartment to the cathode compartment (in the case of oxygen). In some alternate embodiments, fluid may be permitted to flow from the cathode to the anode compartment. Further, the passage discussed above may act to transport electroactive gas from the cathode compartment to the anode compartment (in the case of hydrogen).

Although oxygen and hydrogen are the preferred electroactive gases, other electroactive gases known to one of ordinary skill in the art that may be considered, such as, without limitation, carbon dioxide, chlorine, bromine, iodine, nitrogen, methane, steam and mixtures thereof.

In alternative embodiments of the present invention, a plurality of the thermoelectrochemical cells may be connected electrically in series such that the output voltage of the device is the multiple of the individual cells. Another important embodiment may include the use of NASICON-type materials in the membrane in order to allow only specific alkali ions to be transported under a concentration gradient. This feature makes this electrochemical heat converter significantly more efficient than other devices.

Another aspect of this invention resulting in the specificity of transport of only specific cations through the membrane is the ability of the cell to not self-discharge. If the circuit is opened for a period of time and the heat is no longer provided to vaporize solvent from the anode compartment, the concentration gradient between the anode and cathode will remain. Thus when the cell is ready to be activated, it will have the same ability to generate power as before.

Another aspect of this device is the ability to use a heat source to charge the cell at a rate different than the rate at which it is discharged. Thus the cell can charge continuously with a steady heat source and discharge may be sporadic or vice versa.

In another embodiment, the heating of the anode solution from a plurality of anode compartments may occur at a single heat input source where the condensate is redistributed back to the cell cathode compartments. In other alternate embodiments, water may be supplied to the cathode compartment from an external source along with an electroactive gas to further increase the gradient. Further, when an electrical connection is made between the anode and cathode and an electroactive gas such as oxygen is present at the cathode or hydrogen present at the anode, either dissolved in the solutions or by gas bubbling, electrode reactions occur resulting in electrical current through the circuit.

As briefly described above, the present invention provides a thermoelectrochemical system configured to generate electrical energy using a non-porous ceramic solid electrolyte membrane. The systems each generally include a cell having anode and cathode compartments that are segregated from each other at least in part by the membrane. One of these compartments is provided with a feed having a high concentration of the ion for which the membrane is selective, while the other is provided with a feed having a low concentration of that ion. Ions are sent through the membrane from the side of high concentration to the side of low concentration, generating electrical energy. The systems of the present invention are further constructed to allow flow of solvent in a controlled manner from the chamber of high ion concentration to the side of low ion concentration to preserve the original ion gradient and lengthen life of the system. Several illustrative embodiments of the thermoelectrochemical systems of the present invention are illustrated in the Figures and discussed in greater detail below.

The materials selected for the anode and cathode electrodes of the thermoelectrochemical systems of the present invention are generally good electrical conductors and should be stable in the media to which they are exposed. Any suitable material may be used, and the material may be solid or plated, or perforated or expanded. One suitable electrode material is a dimensionally stable anode (DSA) which is comprised of ruthenium oxide coated titanium (RuO₂/Ti). As known to one of ordinary skill in the art, good anodes may also be formed from nickel, cobalt, nickel tungstate, nickel titanate, platinum and other noble anode metals, as solids plated on a substrate, such as platinum-plated titanium. Stainless steel, lead, graphite, tungsten carbide and titanium diboride are also useful anode materials. Good cathodes can be formed from metals such as nickel, cobalt, platinum, silver and the like, and from alloys such as titanium carbide with small amounts (preferably only up to about 3%) of nickel, FeAl₃, NiAl₃, stainless steel, perovskite ceramics, and the like. Graphite is also a good cathode material. In a preferred embodiment, the electrodes are chosen to maximize cost efficiency effectiveness by balancing electrical efficiency with low cost of electrodes.

The membranes selected for the systems of the present invention selectively transport a particular, desired cation species from the anolyte to the catholyte side, even in the presence of other cation species. The membrane is also significantly or essentially impermeable to water and/or other undesired metal cations. In some specific embodiments, the membrane preferably has a current density from about 0.5 to about 1 A/in², including about 0.6, 0.7, 0.8, and 0.9 A/in². Ceramic NASICON (“Sodium Super Ionic Conductors”) membrane compositions may have comprehensive characteristics of high ion-conductivity for alkali metal ions at low temperatures, high selectivity for alkali metal ions, excellent current efficiency and chemical stability in water, ionic solvents, and corrosive alkali media under static and electrochemical conditions, and may be useful within the scope of the present invention.

Such membranes may have one or more, or all, of the following characteristics which make them suitable for aqueous and non-aqueous electrochemical applications. One characteristic is that, being dense, the membrane may be impervious to water transport, and is not influenced by scaling or precipitation of divalent ions, trivalent ions, and tetravalent ions or dissolved solids present in the solutions. Two other characteristics may be that the membrane does not degrade in the presence of corrosive elements and the membrane may be operated in a wide pH range (2 to 14). Another beneficial characteristic of the membrane may be that it selectively transports sodium ions in the presence of other ions at transfer efficiency above 95%. Yet another characteristic is that the membrane may provide the added benefits of resistance to fouling by precipitants, and/or electro-osmotic transport of water, which is common with organic or polymer membranes. Suitable membranes may also or instead have other characteristics mentioned elsewhere herein.

The advantage of certain ceramic materials is their good ion-conducting characteristics and selectivity under certain conditions. Preferred stiochiometric and non-stoichiometric NASICON materials such as those having the formula for example M¹M²A(BO₄)₃, where M¹ and M² are independently chosen from Li, Na, and K, and where A and B include metals and main group elements, analogs of NASICON have an advantage over beta alumina and other sodium ion-conductors. The multi-oxide NASICON membrane compositions are comparatively stable in water while beta alumina instead hydrates and becomes unstable in aqueous solution. Furthermore, the NASICON materials are better sodium ion conductors than beta alumina at temperatures below 200° C., below 100° C., and at room temperature.

Preferred ceramic membranes are essentially impermeable to at least the solvent components of both the catholyte and anolyte solution. One advantage of these ceramic electrolyte membranes is their low or even negligible electronic conductivity, which virtually eliminates any galvanic reactions from occurring when an applied potential or current is removed from the cell containing the membrane. NASICON membranes typically are very selective to a specific ion and hence have a high transference number of preferred species, implying very low efficiency loss due to near zero electro-osmotic transport of water molecules. Polymeric membranes generally have low transference number of preferred species and, have low transfer efficiency.

As noted above, in a preferred embodiment, the cation conducted by the membrane is the sodium ion (Na⁺). Preferred sodium ion-conducting ceramic membranes include NASICON membrane compositions, including, but not limited to, those listed in U.S. Pat. No. 5,580,430, which is hereby incorporated by reference in its entirety. Analogs of NASICON to transport ions such as Li and K, are also available. The term “NASICON” as used herein denotes membranes for transporting all such ions, including, without limitation, Na, Li, and K. These ion-conducting NASICON membranes are particularly useful in electrolytic systems. Preferred ion specific membranes do not allow transport of water therethrough.

While the ceramic materials disclosed herein encompass or include many formulations of NASICON materials, this disclosure concentrates on an examination of NASICON-type materials for the sake of simplicity. The focused discussion of NASICON-type materials as one example of materials is not, however, intended to limit the scope of the invention. For example, the materials disclosed herein as being highly conductive and having high selectivity include those metal super ion conducting materials that are capable of transporting or conducting any alkali cation, such as sodium (Na), lithium (Li), potassium (K), ions.

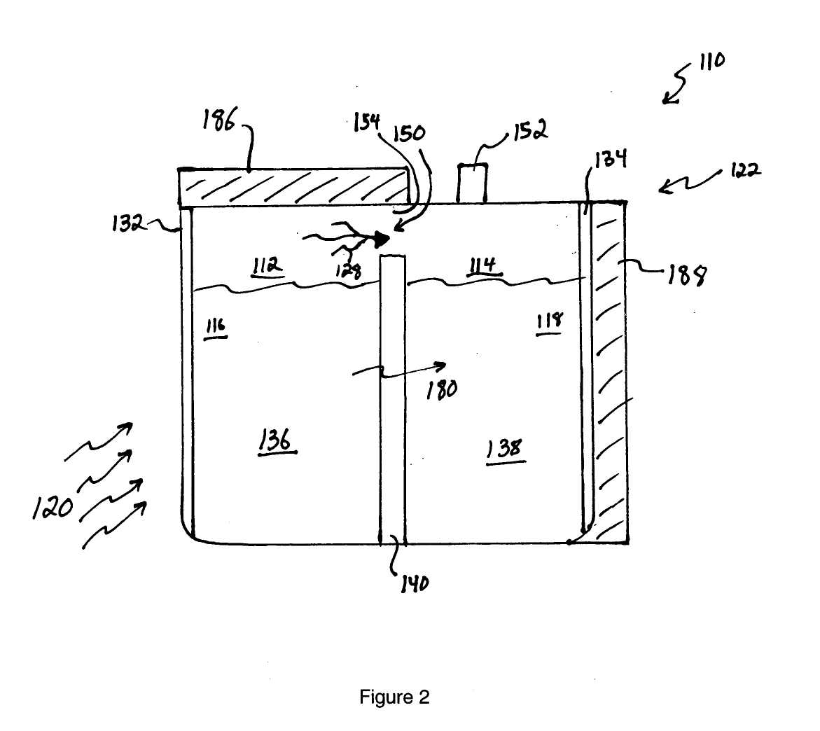

Membranes of NASICON types may be formed by ceramic processing methods such as those known in the art. Such membranes may be in the form of very thin sheets supported on porous ceramic substrates, or in the form of thicker sheets (plates) or tubes. A cell employing a NASICON flat circular disc is illustrated in FIG. 2 of U.S. Patent Publication No. US2005017008, which is incorporated herein by reference.

The ceramic materials disclosed herein are particularly suitable for use in the electrolysis of alkali metal salt solutions because they have high ion-conductivity for alkali metal cations at low temperatures, high selectivity for alkali metal cations, good current efficiency and stability in water and corrosive media under static and electrochemical conditions. Preferred ceramic materials, such as NASICON-type materials, have several orders higher sodium ion conductivity in comparison to beta alumina at temperatures below 100° C. and have comparatively better stability in water.

Preferred ceramic-based alkali metal cation-conducting membranes include one or more of the following features and use characteristics: solid; high alkali ion conductivity at temperatures below 100° C.; high selectivity for particular alkali cations (e.g. Na⁺); sodium transfer efficiency greater than 90%; stability in organic or inorganic sodium salts and chemicals; density greater than 95% of theoretical generally impervious to water transport, electronically insulating; and resistant to acid, alkaline, caustic and/or corrosive chemicals.

Na-ionic conductivity in NASICON structures has an Arrhenius dependency on temperature, generally increases as a function of temperature. NASICON-type materials, especially of the type described herein, have low or negligible electronic conductivity, and as such aid in virtually eliminating the occurrence of any galvanic reactions when the applied potential or current is removed. Preferred NASICON analogs have very mobile cations, including, but not limited to lithium, sodium, and potassium ions, that provide high ionic conductivity, low electronic conductivity and comparatively high corrosion resistance.

An ideal solid electrolyte is an electronic insulator and an excellent ionic conductor. The NaM₂(BO₄), is the best known member of a large family of sodium-conducting compounds and crystalline solutions that have been extensively studied. The structure has hexagonal arrangement and remains stable through a wide variation in atomic parameters as well in the number of extra occupancies or vacancies.

In NaM₂(BO₄), all the sodium atoms are at one of the inequivalent positions available for sodium ion and therefore show poor sodium ion conductivity (8.71×10⁻⁷ S/cm at 90° C.). The low ionic conductivity at temperatures below 100° C. of NASICON-type compositions reported in scientific literature (J. B. Goodenough, H. Y. Hong, and J. A. Kafalas, Materials Res. Bull), is attributed to the fact that pure monophase compositions, free of secondary phase, which precipitates as an impurity, cannot be prepared. Researchers have shown that the ionic conductivity of NASICON type compositions is clearly equivalent to those of β¹¹-Alumina, at 300° C., (H. Y. Hong, Materials Res. Bull. 11(1976), 173; 11(1976) 203; J. P. Boilet, P. H. Colomban, Solid State Ionics 28-30 (1988) 403-410.) The low conductivity in NASICON compounds reported in literature below 300° C. is attributed to the presence of a low conducting phase that is produced as a secondary phase.

Preferred ceramic membranes include the ceramic NASICON type membranes include those having the formula NaM₂(BO₄), and those having the formula M¹M²A(BO₄)₃, but also including compositions of stiochiometric substitutions where M¹ and M² are independently chosen to form alkali analogs of NASICON. Substitution at different structural sites in the above formula at M¹M², A, and B may be filled by the 2+, 3+,4+, 5+valency elements. Other suitable alkali ion conductor ceramic materials have the formula: M₁₊ₓA₂₋ₓN_{y}BₓC₃₋ₓO₁₂(0<x<2) (O<y<2), where M¹M²=Li, Na, K, and non-stiochiometric compositions, in the above formulation with substitution at different structural sites in the above formula M¹, M², A, N, B and C by the 2+, 3+, 4+, 5+valency elements.

The processing of Na₃Zr₂Si₂PO₁₂ and Na₅RESi₄O₁₂ type NASICON compositions (where RE is either Yttrium or a rare earth element) proceeds as follows. Through an extensively designed approach, the membranes are systematically synthesized by solid-state oxide mixing technique. A mixture of the starting precursors is mixed in methanol in polyethylene jars. The mixed precursor oxides are dried at 60° C. to evolve the solvent. The dried powder or material is calcined at 800° C. to form the required composition. The calcined material is wet ball milled with zirconium oxide media (or other metal media) to achieve the prerequisite particle size distribution. Green membranes at 0.60 to 2.5 inch diameter sizes are pressed by compaction in a die and punch assembly and then sintered in air at temperatures between 1100° C. and 1200° C. to make dense ceramic oxides. XRD analysis of NASICON compositions is performed to identify the crystal structure and phase purity. Many of the NASICON compositions referred to herein are stiochiometric and non stiochiometric compositions of Na₃Zr₂Si₂PO₁₂ type formula. Non Stiochiometric means un-equivalent substitution of Zr, Si, and/or P in the formula. Such compositions have Ti, Sn, and Hf partial substitution at the Zr site. In other NASICON compositions there is partial substitution of Ti, Sn, and Ge at the Zr, Si, and P sites. Examples of compositions and processing for NASICON include the following: S. Balagopal, T. Landro, S. Zecevic, D. Sutija, S. Elangovan, and A. Khandkar, “Selective sodium removal from aqueous waste streams with NASICON ceramics”, Separation and Purification Technology 15 (1999) 231-237; Davor Sutija, Shekar Balagopal, Thom Landro, John Gordon, “Ceramic Cleansers, Environmental applications of Sodium Super-Ionic Conducting Ceramics”, The Electrochemical Soc. Interface. 5 (4) (1996) 26; R. D. Shannon, B. E. Taylor, T. E. Gier, H. Y. Chen, T. Berzins, Ionic Conductivity in Na, YSi₄O₁₂ type silicates, Inorg. Chem. 17 (4) (1978) 958.; S. H. Balagopal, J. H. Gordon, A. V. Virkar, A. V. Joshi, U.S. Pat. No. 5,580,430, 1996; and J. B. Goodenough, H. Y. P. Hong, J. A. Kafalas, Fast Na+ ion transport in skeleton structures, Mater. Res. Bull. 11 (1976) 203.

The stability or resistance to corrosive media of the membrane materials described herein may be enhanced by chemistry variation. Ability to synthesize phase pure compositions based on variations in chemistry, substitution pattern at various sites of the structure, and processing methods has yielded highly sodium ion conductive compositions. NASICON compositions may provide benefits in ionic conductivity, corrosion resistance, transfer efficiency, and mechanical properties. The thermodynamic analysis show the structure of the modified NASICON compositions through ionic substitution by crystal chemistry approach provides excellent chemical stability in corrosive environments (i.e., acidic or caustic or organic solvents). These membranes are particularly suitable for electrolytic decomposition of sodium salts to produce sodium based organic and inorganic chemicals. However, other NASICON-type formulations which have one or more of the preferred characteristics described herein are equally as suitable.

The membranes used in the thermoelectrochemical cells of the present invention may have flat plate geometry, tubular geometry, or supported geometry. The solid membrane is preferably sandwiched between two pockets, preferably made of a chemically-resistant HDPE plastic and sealed, preferably by compression loading using a suitable gasket or o-ring, such as an EPDM o-ring.

The phrase “significantly impermeable to water”, as used herein, means that a small amount of water may pass through the membrane, but that the amount that passes through is not of a quantity to diminish the usefulness of the system. The phrase “essentially impermeable to water”, as used herein, means that no water passes through or that if water passes through the membrane, its passage is so limited so as to be undetectable by conventional means. The words “significantly” and “essentially” are used similarly as intensifiers in other places within this specification.

An example of an overall electrolytic reaction, using sodium hydroxide as the source of sodium ion, is as follows:
2OH⁻=½O₂+H₂O+2e⁻ Anode:
2CH₃OH+2e⁻+2Na⁺=2NaCH₃O+H₂ Cathode:
2CH₃OH+2NaOH=2NaOCH₃+H₂+½O₂+H₂O Overall:

These reactions are electrolytic reactions, taking place under an induced current wherein electrons are introduced or are removed to cause the reactions. The reactions proceed only so long as a current is flowing through the cell. Contrary to electrolytic reactions, galvanic reactions may occur when an applied potential to the cell is removed, which tends to reduce the efficiency of the electrolytic cell. It is preferred that only electrolytic reactions occur in the cell and that galvanic reactions be eliminated or, at least, greatly minimized. Alternatively, the NaOH used in the anolyte and catholyte could be substituted with LiOH or KOH, corresponding with the selectivity of the particular cation-specific membrane being used.

The anolyte solution which is the source of the sodium cation or other alkali metal cation in the process may be a neutral salt, such as sodium chloride, or it may be a caustic solution such as sodium hydroxide. Solutions or by-products of industrial processes may be used as a sodium source. In one embodiment, aqueous sodium hydroxide is used. Sodium hydroxide is may often be inexpensive to obtain, and its use produces water and oxygen gas at the anode. Accordingly, although the discussion which follows is based on use of sodium hydroxide, it can be adapted to other sodium based chemicals, with the understanding that the reaction gas products at the anode will differ depending on the chemistry of the salt used in the anolyte.

A first embodiment of the thermoelectrochemical systems of the present invention is illustrated as the system 10 of FIG. 1. The system 10 of FIG. 1 features an electrochemical cell 22 comprising an anode chamber 16 and a cathode chamber 18 separated from each other by a membrane 40. In system 10, the anode chamber 16 contains an anode 32 and an anolyte solution 36 having a high concentration of a selected solute, in this instance may be Na⁺ ions. Other similar solutes for use in identical or similar membrane systems are known to those in the art. Similarly, the solvents used may be widely varied within the scope of the present invention. One solvent usable in this instance is water. Alcohols may similarly be used in some embodiments. The cathode chamber 18 comprises a cathode 34 and a catholyte solution 38 having a low concentration of the solute of the anode chamber 16.

In addition to the anode chamber 16, cathode chamber 18, anode and cathode 32 and 34, respectively, and the membrane, the system 10 of FIG. 1 further includes a link 50 adapted to transmit solvent from the chamber of high concentration (in this system the anode chamber 16) to the chamber of low concentration (here, the cathode chamber 18). In some embodiments, this link 50 has a physical form and is an individual component, while in others, the link 50 comprises regions of the anode chamber 16 and cathode chamber 18 at which the solvent vaporizes and condenses, respectively.

To operate the cell 22 of the system 10 of FIG. 10, it is exposed to a source of heat 20 such that the chamber of high ion concentration, again, in this embodiment, the anode chamber 16, is heated. The membrane 40 transports the ions 80 from the anode chamber 16 into the cathode chamber 18, and the current generated is harnessed by the electrical leads 60. Hydrogen may be produced at the cathode and oxygen at the anode. As the anode chamber 16 is heated, the solvent present in the anode chamber 16 begins to vaporize at the zone of solvent vaporization 12 to become vapor 28. The solvent vapor 28 then enters the link 50, which, in some variations of the devices of the present invention may simply be an orifice, opening, or other fluid or vapor connection between the two chambers 16, 18, and passes a heat sink 52 or other device adapted to cause the vapor 28 to condense in a zone of solvent condensation 14 and be added to the cathode chamber 18. In this way, the system 10 of FIG. 1 acts to preserve the initial conditions provided; i.e., as ions 80 travel from the chamber of high concentration to the chamber of low concentration, evaporation and condensation of the solvent 28 allow it to also travel from (in this embodiment) the anode compartment 16 to the cathode compartment 18. This acts to preserve the high concentration of solute in the anode chamber 16 and the dilute concentration of the cathode compartment 18. The remaining Figures describe other potential embodiments of the system 10 of the present embodiment.

It should be understood that the source of the heat 20 provided to the anode chamber 16 is unimportant, as a wide variety of heat sources may be usable within the scope of the present invention. Solar energy is one potential source of the heat energy used as an input in the systems such as system 10 of FIG. 10 to drive transport of solvent from one chamber to another.

Referring next to FIG. 2, a second embodiment of the thermoelectrochemical cell-based system of the present invention is illustrated. More specifically, system 110 is illustrated, similarly comprising a cell 122 having an anode compartment 116 and a cathode compartment 118. As above, the anode chamber 116 contains an anode 132 and an anolyte solution 136. The anode 132 may be a metal, conductive ceramic, or other anode, as known to one of ordinary skill in the art. The anolyte solution 136, as previously, is characterized by a high concentration of an ion, in this case, Na⁺. The anode compartment 116 is segregated from the cathode compartment 118 at least in part by a membrane 140, in this case a non-porous, ion-specific, alkali-ion solid electrolyte NASICON membrane selective for the transport of Na⁺ ions. The cathode chamber 118 comprises a cathode 134 and a catholyte solution 138 having a low concentration of the solute of the anode chamber 116. The cathode 134 may be a metal, conductive ceramic, or other electrode as known to one of ordinary skill in the art.

System 110 includes a link 150 as discussed above in the form of an open channel 154 connecting the anode and cathode chambers 116, 118. Such a channel 154 could transmit vaporized solvent 128 from the anode chamber 116 as it is formed. Thus, as thermal energy is received from the heat source 120 directed at the anode chamber 116, solvent is vaporized to form vapor 128 at a zone of vaporization 112, concentrating the anolyte 136. The vapor 128 is then conducted to the cathode chamber 118, where heat is removed by a heat sink 152, resulting in condensation of the vapor 128 at condensation zone 114, after which the condensate joins the catholyte 138, diluting it.

In some embodiments, as condensate flows into the catholyte 138, the level of the catholyte 138 rises within the cell 122 to a point where it flows over membrane 140, adding to the anolyte 136 and thus transporting salt from the catholyte 138 to the anolyte 136 to potentially somewhat offset the transport of ions 180 (such as here cations) passing from the anolyte 136 to the catholyte 138 through the membrane 140 when electrical current passes through the system 110. During the course of electrode reactions, electroactive gas may also pass from one compartment to another through the same path as the vapor 128.

In system 110 of FIG. 2, the anode chamber may contain insulation 186 to retain heat received from the heat source 120. In addition, systems such as 110 of FIG. 2 may contain insulation 188 on the cathode chamber 118 to protect it from heat and help to preserve a temperature differential created by a heat sink 152 to allow the solvent vapor 128 to condense and be added to the catholyte 138, preserving its dilute nature. Surfaces intended to be exposed to the heat source would generally not be insulated. As briefly noted above, this further helps preserve the concentrated nature of the anolyte solution 136.

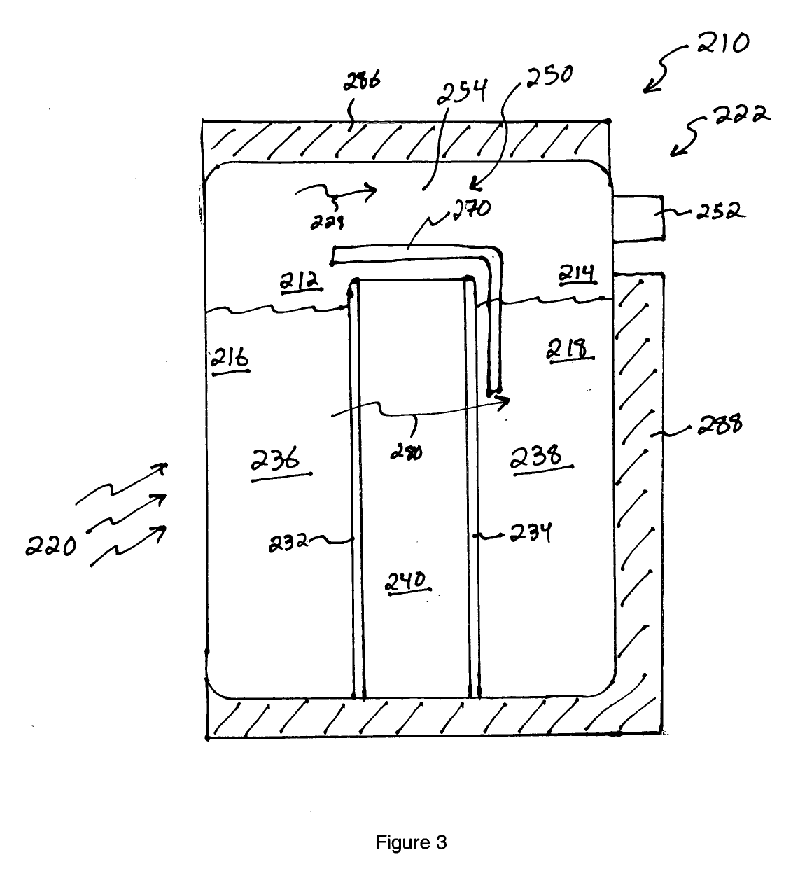

Referring next to FIG. 3, a third embodiment of the thermoelectrochemical system 210 of the present invention is shown. As previously described, the system 210 includes a cell 222 with an anode compartment 216 and a cathode compartment 218. In system 210, the anode 232 and cathode 234 are porous in nature and may thus be attached to the membrane 240. In some configurations, such anodes 232 and cathodes 234 may be printed onto the membrane 240. As above, the anolyte solution 236 is characterized by a high concentration of an ion, and is divided from the cathode compartment 218 at least in part by a non-porous, ion-specific, alkali-ion solid electrolyte membrane 240. The cathode chamber 218 comprises a cathode 234 and a catholyte solution 238 of low ionic concentration.

System 210 of FIG. 3 further illustrates a solvent return path 270 configured such that more dilute condensate does not mix with the catholyte 238 until it has flowed in close proximity to the cathode 234. This minimizes bypass of dilute condensate into the overflow that returns to the anode chamber 216 and helps to provide overflow of catholyte 238 to the anode chamber 216 that has as high a solute concentration as possible. In the case where oxygen is an electroactive gas present in the system, the condensate forms in the presence of the oxygen gas and is in equilibrium with the gas before flowing along the cathode, where the gas may be consumed.

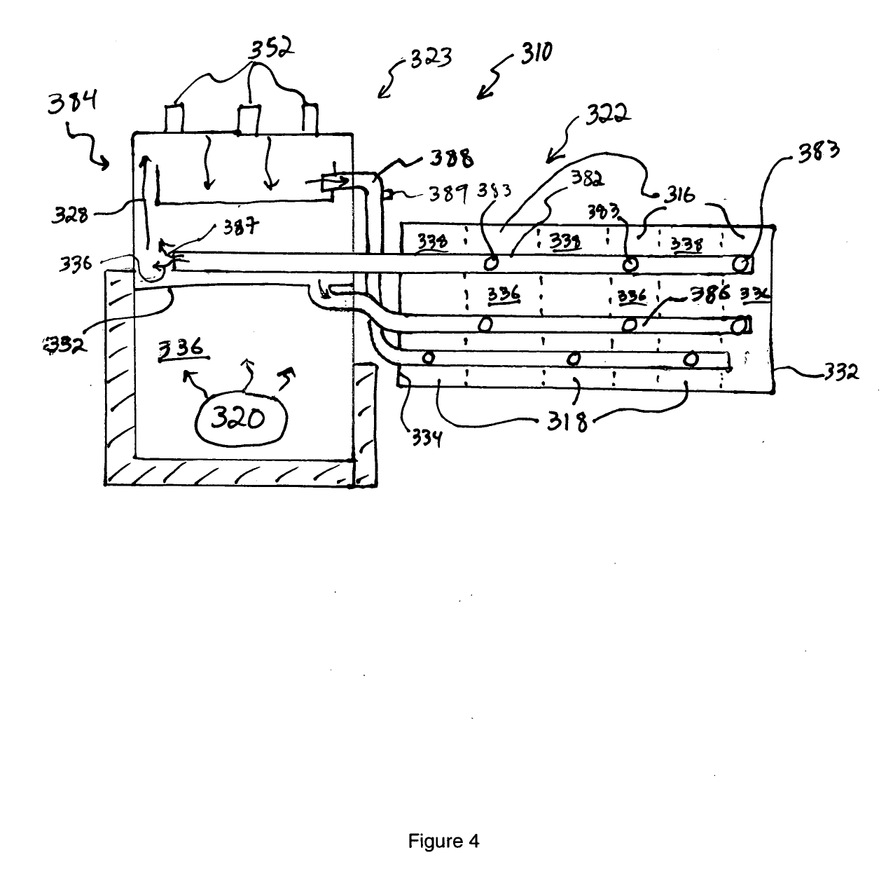

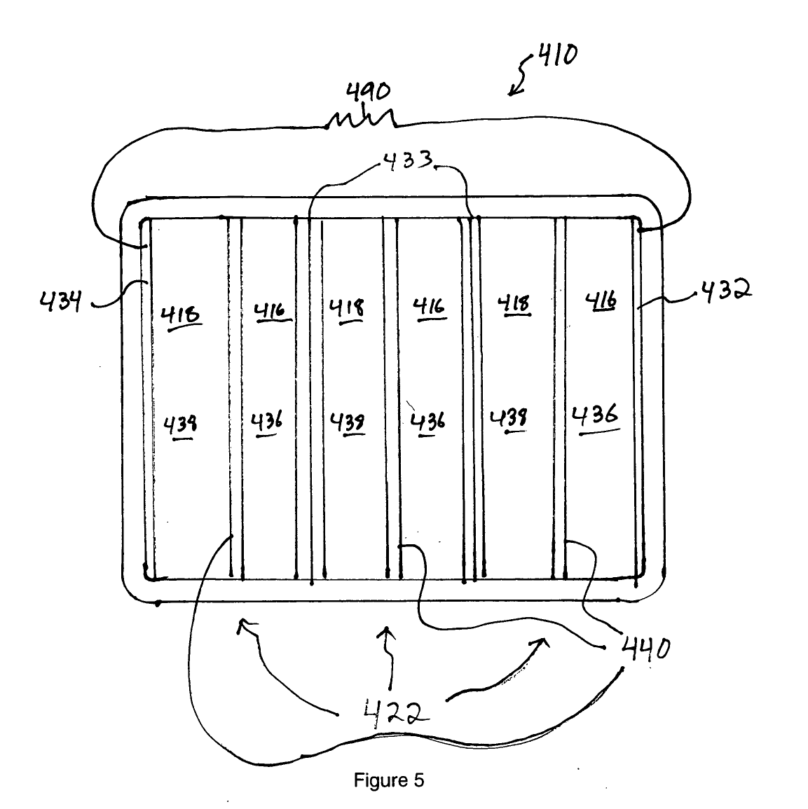

Referring next to FIG. 4, yet another embodiment of the thermoelectrochemical systems of the present invention is illustrated. System 310 includes a cell or bank of cells 322 and a thermal energy recovery system 323. In system 310, anolyte 336 from a single cell 322 or multiple similar cells arranged either in series or in parallel, or as a bipolar cell as illustrated in FIG. 5 and described below, is collected in a header 382 via ports 383. As oxygen is generated at the anode 332, an upward circulation promotes flow of the less-concentrated anolyte 336 into the header 382 leading to the distillation chamber 384 concurrently with a flow of oxygen 387. As solvent vaporizes from the anolyte 336 to form vapor 328, the more concentrated anolyte 336 flows back to the bottom of the anode chambers through header 386. Condensing solvent condenses at a level higher than the cells and condensate flows to the cathode compartments through header 388. The condensate is in equilibrium with the oxygen 387 in the distillation chamber headspace 384 but supplementary oxygen may be introduced into the system through a port 389. Port 389 may be configured such that the flow of flow of the condensate draws in oxygen-containing gas through a venturi effect. A carbon dioxide trap may be desirable if cell solutions have high ph in order to avoid formation of carbonates. The condensate return port 388 may also be arranged so as to return heat to the anolyte collection header 382 in order to preheat the anolyte 336 prior to heating in the distillation chamber 384.

Referring lastly to FIG. 5, all of the elements of the previous Figures are similarly labeled. Here, cells 422 are configured in series. An anode 432 is located at one end of the cell bank connected to the external circuit and a cathode 434 is located at the opposite end of the cell bank connected to the circuit 490. Membranes 440 are provided within the cells as previously discussed. Anolyte 436 and catholyte 438 are distributed within the anode and cathode chambers 416, 418 as taught above. Between cells are bipolar plates 433 where one side serves as cathode and opposite side serves as anode. All cells 423 within the bank operate at the same current and the voltage output of the bank is the sum of the voltage contribution of each of the individual cells 423. With such a cell bank it is convenient to utilize a central thermal regeneration configuration as shown in FIG. 4.

Several examples are provided below which discuss the construction, use, and testing of specific embodiments of the present invention. These embodiments are exemplary in nature and should not be construed to limit the scope of the invention in any way.

### EXAMPLE 1

In a first example, 15M NaOH is dissolved in water in the anode compartment and 0.1M NaOH is dissolved in water in the cathode compartment that also contains dissolved oxygen. A sodium ion conductive NASICON membrane separates the two solutions. When the circuit is completed the anode reaction occurs:
NaOH=>Na⁺+0.5H₂O+0.25O₂+e⁻

The cathode reaction is:
Na⁺+0.5H₂O+0.25O₂+e⁻=>NaOH

As the reactions occur, Na+transports through the NASICON membrane, oxygen is vented from the anode compartment and oxygen is consumed from the cathode compartment.

The cell voltage, current and cell power are a function of the log ratio between the concentration of the anode compartment solution and the cathode compartment solution as described by the well-known Nernst equation. If the cell were permitted to run without regeneration, the NaOH concentration in the anode compartment would decline and the concentration in the cathode compartment would rise resulting in decreasing cell driving force. But through the heat regeneration described, the cell concentrations can be maintained for longer periods of time. As oxygen vents from the anode, it transports through the solvent vapor passage and enters the cathode compartment with the solvent condensate to become available fro consumption at the cathode. If the cell circuit is broken by a switch to interrupt the current, water is not permeable through the NASICON, so the concentration gradient does not deteriorate. If no thermal regeneration occurs, the cell discharge will resume at the same potential if the circuit is switched back on. Or if the thermal regeneration continues while the cell is switched off, the cell potential will be greater when the cell is switched back on.

### EXAMPLE 2

5M sodium methoxide is dissolved in methanol and 1 M water in the anode compartment and 0.1M sodium methoxide is dissolved in methanol and 1 M water in the cathode compartment that also contains dissolved oxygen. A sodium ion-conductive NASICON membrane separates the two solutions. When the circuit is completed the anode reaction occurs:
MeONa+0.5H₂O=>Na⁺+MeOH+0.25O₂+e⁻

Where Me represents a methyl group,

The cathode reaction is: Na⁺+MeOH+0.25O₂+e⁻=>MeONa+0.5H₂O

As the reactions occur, Na⁺ transports through the NASICON membrane, oxygen is vented from the anode compartment and oxygen is consumed from the cathode compartment. The cell voltage, current and cell power are a function of the log ratio between the concentration of the anode compartment solution and the cathode compartment solution as described by the well-known Nernst equation. In this example the solvent is methanol which is the primary solvent vaporized from the anode solution and condensed to dilute the cathode solution to maintain the concentration gradient. The advantage of using methanol over water as the solvent is the much lower operating temperatures possible since methanol freezes at much lower temperature compared to water.

### EXAMPLE 3

Electroactive gases other than oxygen may be used for the process, such as hydrogen. 5M sodium methoxide is dissolved in methanol in the anode compartment that also contains dissolved hydrogen and 0.1M sodium methoxide is dissolved in methanol and in the cathode compartment. A sodium ion conductive NASICON membrane separates the two solutions. Here electrodes are selected with high oxygen overpotentials but low hydrogen overpotentials. When the circuit is completed the anode reaction occurs:
MeONa+0.5H₂=>Na⁺+MeOH+e⁻

The cathode reaction is:
Na⁺+MeOH+e⁻=>MeONa+0.5H₂

As the reactions occur, Na⁺ transports through the NASICON membrane, hydrogen is vented from the cathode compartment and hydrogen is consumed from the anode.

While specific embodiments of the present invention have been illustrated and described, numerous modifications come to mind without significantly departing from the spirit of the invention, and the scope of protection is only limited by the scope of the accompanying claims.

What is claimed is:

1. A thermoelectrochemical device comprising:
an electrochemical cell having an anode and a cathode, the anode being separated from the cathode by a cation-conducting non-porous solid electrolyte membrane;
an anolyte solution having a solvent and a solute provided at the anode;
a catholyte solution having a solvent and a solute provided at the cathode;
a source of thermal energy configured to provide thermal energy to the anolyte solution to form solvent vapor from the anolyte solution; and
a solvent vapor transfer for transporting solvent vapor to the cathode to become catholyte solution.

2. The thermoelectrochemical device of claim 1 wherein the cation-conducting non-porous solid electrolyte membrane is an alkali ion-conducting NASICON membrane.

3. The thermoelectrochemical device of claim 3 wherein said alkali ion-conducting NASICON material has the formula M₍₅₋ₓ₎RE₍₁₊ₓ₎Si₄O₁₂, where M is selected from the group consisting of Na, Li, or K, where RE is a rare earth metal or Yttrium, and where 0≦x≦3.

4. The thermoelectrochemical device of claim 1 wherein the solvent is water.

5. The thermoelectrochemical device of claim 1 wherein the solvent is an alcohol.

6. The thermoelectrochemical device of claim 1 wherein the solute is sodium hydroxide.

7. The thermoelectrochemical device of claim 1 wherein the solute is the sodium alcoxide of the alcohol used as solvent.

8. The thermoelectrochemical device of claim 1, wherein at least one of the anode and/or the cathode is attached to the cation-conducting non-porous solid electrolyte membrane.

9. A thermoelectrochemical device comprising:
an electrochemical cell having an anode and a cathode provided in an anode compartment and a cathode compartment, respectively, the anode compartment being separated from the cathode compartment by a cation-conducting non-porous solid electrolyte membrane;
an anolyte solution provided in the anode compartment containing a solvent and concentrated solute cations;
a catholyte solution provided in the cathode compartment containing a solvent and dilute solute cations relative to the anolyte solution;
a thermal energy source for providing thermal energy to the anolyte solution to form solvent vapor; and
means for transporting solvent vapor formed from the anolyte solution from the anode compartment to the cathode compartment and means for cooling said vaporized solvent to condense the solvent.

10. The thermoelectrochemical device of claim 9 further comprising a heat transfer system to condense the solvent vapor and transfer the heat to the anolyte solution.

11. The thermoelectrochemical device of claim 9 wherein the cation-conducting non-porous solid electrolyte membrane is an alkali ion-conducting NASICON membrane.

12. The thermoelectrochemical device of claim 11 wherein said alkali ion-conducting NASICON material has the formula M₍₅₋ₓ₎RE₍₁₊ₓ₎Si₄O₁₂, where M is selected from the group consisting of Na, Li, or K, where RE is a rare earth metal or Yttrium, and where 0≦x≦3

13. The thermoelectrochemical device of claim 9 wherein the solvent is water.

14. The thermoelectrochemical device of claim 9 wherein the solvent is an alcohol.

15. The thermoelectrochemical device of claim 9 wherein the solute is sodium hydroxide.

16. The thermoelectrochemical device of claim 9 wherein the solute is the sodium alcoxide of the alcohol used as solvent.

17. The thermoelectrochemical device of claim 9, wherein at least one of the anode and/or the cathode is attached to the cation-conducting non-porous solid electrolyte membrane.

18. A thermoelectrochemical device for generating power from thermal energy comprising:
an electrochemical cell having an anode compartment with an anode and a cathode compartment with a cathode, the anode compartment and the cathode compartment being separated by a cation conducting non-porous solid electrolyte membrane;
an anolyte solution provided in the anode compartment containing a high concentration of solute cations;
a catholyte solution provided in the cathode compartment containing a low concentration of solute cations;
a thermal energy source configured to provide thermal energy to the anolyte solution;
means for transporting vaporized solvent from the anode compartment to the cathode compartment;
means for cooling said vaporized solvent to result in condensing solvent; and
means for transport of an electroactive gas between the anode and the cathode compartments.

19. The thermoelectrochemical device of claim 18 wherein the electroactive gas comprises oxygen, hydrogen, carbon dioxide, chlorine, bromine, iodine, nitrogen, methane, steam and mixtures thereof.

20. The thermoelectrochemical device of claim 18, further comprising means for transporting catholyte solution to the anode compartment.
